(19) United States
(12) Patent Application Publication
(10) Pub. No.: US 2023/0278382 A1
(43) Pub. Date: Sep. 7, 2023

(54) SEVEN BLADE RV FEMALE CONNECTOR

(71) Applicants: Bahman Sobbi, Calgary (CA); Bahram Sobbi, Calgary (CA)

(72) Inventors: Bahman Sobbi, Calgary (CA); Bahram Sobbi, Calgary (CA)

(21) Appl. No.: 18/174,690

(22) Filed: Feb. 27, 2023

Related U.S. Application Data
(60) Provisional application No. 63/316,002, filed on Mar. 3, 2022.

(51) Int. Cl. B60D 1/64; H01R 9/03; H01R 13/447; H01R 13/11; H01R 13/52

(52) U.S. Cl. CPC B60D 1/64; H01R 9/031; H01R 13/447; H01R 13/113; H01R 13/5213; H01R 2201/26

(57) ABSTRACT

A seven blade rv female connector has quick connect electrical connectors for electrically connecting wires of a vehicle electrical system to the socket for coupling with a corresponding plug of a towed vehicle. The quick connect electrical connectors allow electrical connection of wires to the socket without requiring electrical connectors being individually connected to each wire.

### REFERENCE TO RELATED APPLICATIONS

This application claims the benefit of Provisional Patent Application Ser. No. 63/316,002 filed Mar. 3, 2022, the entirety of which is incorporated herein by reference.

### FIELD OF THE INVENTION

The present disclosure relates to trailer electrical connectors and, more particularly, to a seven blade rv female connector with quick connect wiring terminals.

### BACKGROUND OF THE INVENTION

Conventionally, a towed vehicle may be connected to a towing vehicle by a to operate the various driving lights or signals on the towed vehicle such as the brake lights, the tail and license lights, the turn signals, and other equipment such as brakes. An electrical connector having a plug and socket is used to removably connect the electrical systems of the towing vehicle and the trailer. The electrical system of the towing vehicle is wired to the socket and the electrical system of the towing vehicle is wired to the plug.

Existing electrical connectors, including the towing vehicle carried socket or female connector tend to be difficult, time consuming, and cumbersome to install and connect with the vehicle electrical system. Connecting these prior socket connectors to the vehicle electrical system is a tedious job that requires using many tools and various electrical connectors for making the appropriate electrical connections.

For example, existing to connect socket connectors to the electrical system wires must be striped and fitted with ring terminals on the striped wire ends. These wires are then secured to threaded electrical couplings via the ring terminals, which require lock washers, nuts, and tightening thereof to make the electrical connection. This process is time consuming, laborious, requires many different tools and electrical connectors.

Accordingly, there is a need and desire to have a new seven-way trailer connector socket that overcomes the foregoing described and other drawbacks with existing trailer connector sockets.

### SUMMARY OF THE INVENTION

Embodiments of the invention provide a seven-way trailer connector socket that overcomes the drawbacks of existing trailer connector sockets by having quick connect electrical connectors for electrically connecting wires to the socket electric contacts.

The quick connect electrical connectors allow connecting wires to the trailer connector socket without attaching electrical connectors to the ends of the wires. This eliminates the need for specialty tools, reduces complexity and time to install, and eliminates possible failure points. Further, the quick connect electrical connectors allow the wires to be disconnected from the trailer connector socket without needing to be cut.

Numerous additional objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 a perspective view of a seven blade rv female connector that is constructed in accordance with an embodiment of the invention;

FIG. 2 is a side view of a seven blade rv female connector that is in accordance with an embodiment of the invention;

FIG. 3 is a rear perspective view of a seven blade rv female connector that is constructed in accordance with an embodiment of the invention; and

FIG. 4 is another perspective top view of a seven blade rv female connector that is constructed in accordance with an embodiment of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized, and changes can be made without departing from the scope of the disclosure.

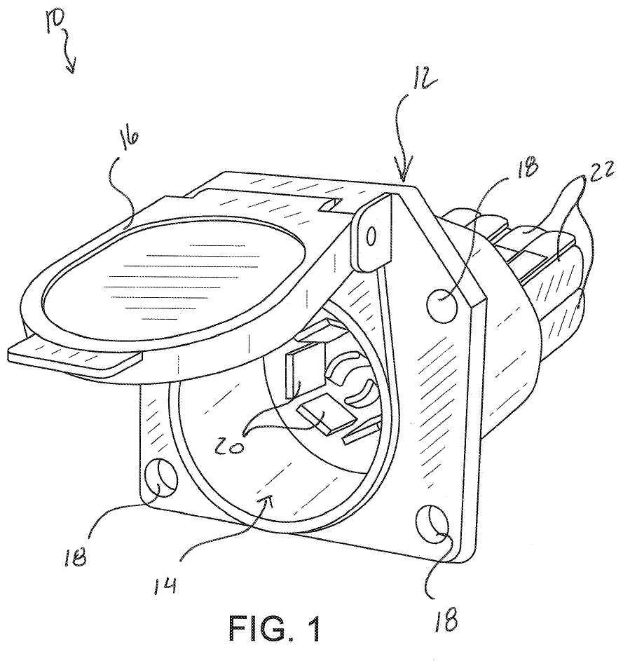

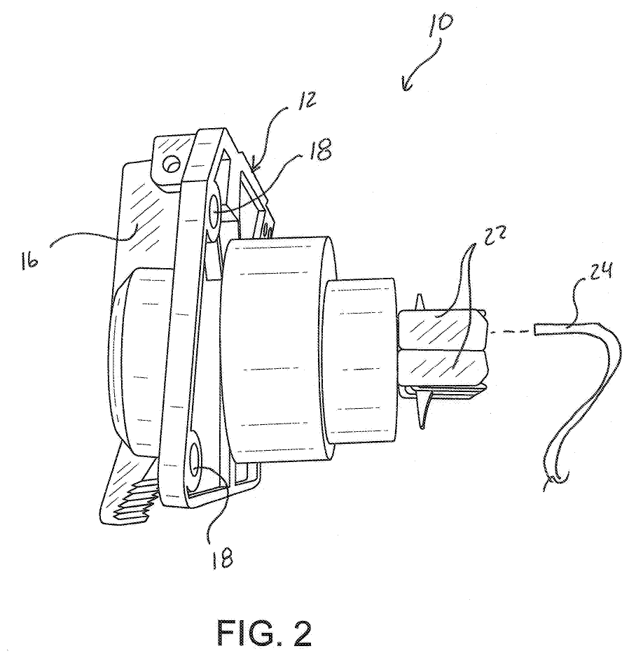

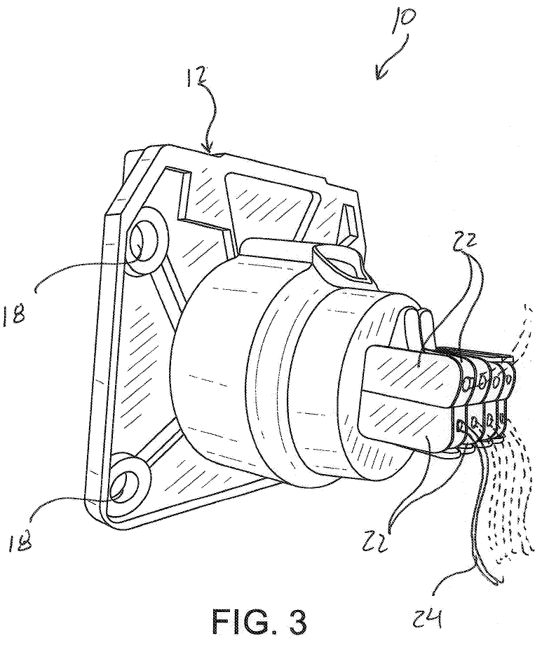

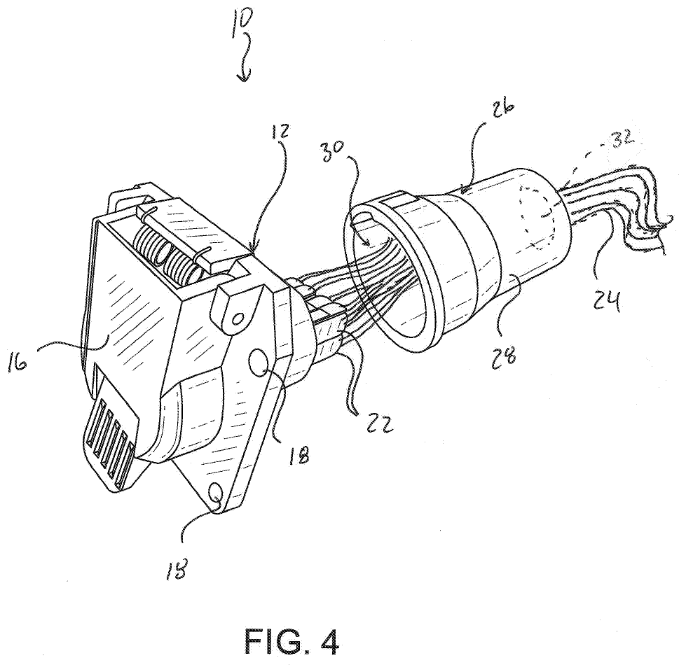

Turning now to FIGS. 1-4 of the drawings, a seven blade rv female connector 10 that is constructed in accordance with an embodiment of the invention is illustrated. The connector 10 has a housing 12 with a socket 14 at its front end and a lid 16 hingedly connected to the housing for sealing or closing the socket. The socket 14 is configured to removably receive a mating plug (not shown) for electrically connecting a towing vehicle to a towed vehicle as well known in the field of the invention. The housing 12 has a plurality of mounting holes 18 to allow mounting or attaching the housing to a towing vehicle.

A plurality and, more particularly, seven blade-type electrical contacts 20 are arranged in the socket for releasable coupling with corresponding female electrical contacts carried by a mating plug. The electrical contacts 20 are arranged in a standard seven-way trailer connector configuration for coupling with a standard seven-way trailer plug, as well known in the field of the invention.

The connector 10 has a plurality of quick connect electrical terminals 22 arranged on the back side of the housing 12. There are at least seven quick connect electrical terminals 22, each corresponding to a respectively blade electrical contact 20. Corresponding quick connect electrical terminals 22 and electrical contacts are electrically connected. Each quick connect electrical terminal 22 is configured such that an end of a corresponding wire 24 can simply be inserted into the connector and the connector operated to secure the wire to the connector while at the same time making an electrical connection. To this end, no tools are required to secure the wires to the terminal for electrical coupling. In embodiments, the terminals 22 can be used with 12-22 gauge wire.

The quick connect electrical terminals 22 could be the electrical connectors and/or terminals shown in described in U.S. Pat. No. 4,541,679 and/or shown and described in U.S. Pat. No. 6,238,233, the disclosures of both being incorporated herein in their entirety. One of ordinary skill in the art will appreciate that other quick connect electrical connectors could also be used, as such the invention is not limited solely to the electrical connectors and/or terminals shown and disclosed by these two patents.

The connector 10 may also have a boot or covering 26 that is removably connectable to the housing 12 to cover and enclose the electrical terminals 22 to prevent water and debris intrusion to those terminals. The covering 26 has a body 28 defining a central passage 30 that is open on its front end for receiving the back side of the housing 12 and the electrical terminals 22 within the passage. The body 28 also has an opening or aperture 32 at its back end for the passage of wires into the passage 30 for connection to the terminals 22.

It will be appreciated by persons skilled in the art that the present embodiment is not limited to what has been particularly shown and described hereinabove. A variety of modifications and variations are possible in view of the above teachings without departing from the scope of the disclosure.

What is claimed is:

1. An electrical connector for coupling the electrical system of a towed vehicle with the electrical system of a towing vehicle, the electrical connector comprising:
a housing having a front end and a back end;
the housing having a socket at its front end;
a plurality of male blade-type electrical contacts arranged in the socket for releasably coupling with corresponding female electrical contacts of a mating plug; and
a plurality of quick connect electrical terminals on the back end of the housing, one for each respective male blade-type electrical contact and being electrically connected therewith.

2. The electrical connector of claim 1, wherein the housing has mounting holes for attaching the housing to the towed vehicle.

3. The electrical connector of claim 1, further comprising:
a lid hingedly connected to the housing for sealing the socket.

4. The electrical connector of claim 1, wherein the plurality of male blade-type electrical contacts include seven of male blade-type electrical contacts.

5. The electrical connector of claim 1, further comprising:
a boot that is removably connectable to the housing to cover and enclose the quick connect electrical terminals.

6. An electrical connector for coupling the electrical system of a towed vehicle with the electrical system of a towing vehicle, the electrical connector comprising:
a housing having a front end and a back end;
the housing having a socket at its front end;
a seven male blade-type electrical contacts arranged in the socket for releasably coupling with corresponding female electrical contacts of a mating plug;
a plurality of quick connect electrical terminals on the back end of the housing, one for each respective male blade-type electrical contact and being electrically connected therewith;
wherein the housing has mounting holes for attaching the housing to the towed vehicle;
a lid hingedly connected to the housing for sealing the socket; and
a boot that is removably connectable to the housing to cover and enclose the quick connect electrical terminals.
